(19) United States
(12) Patent Application Publication
(10) Pub. No.: US 2014/0344581 A1
(43) Pub. Date: Nov. 20, 2014

(54) Secure Upgrades for Field Programmable Devices

(71) Applicant: Cisco Technology, Inc., San Jose, CA (US)

(72) Inventors: Anthony H. Grieco, Wake Forest, NC (US); Chirag Shroff, Cary, NC (US)

(73) Assignee: Cisco Technology, Inc., San Jose, CA (US)

(21) Appl. No.: 13/895,552

(22) Filed: May 16, 2013

(51) Int. Cl. H04L 9/14; H04L 9/32

(52) U.S. Cl. CPC H04L 9/14; H04L 9/3247
USPC 713/176; 713/150

(57) ABSTRACT

Techniques are provided for securely upgrading a field programmable circuit, e.g., a Field Programmable Gate Array (FPGA), in a device that has been deployed to a customer site. A plurality of keys is stored in the device, e.g., public, private, and/or symmetric keys. The keys are used to authenticate and decrypt a newly received FPGA software image upgrade. The image upgrade is re-encrypted using one of the stored keys and stored in the computing device. The device is booted and the encrypted image upgrade is loaded into the field programmable circuit. The encrypted image upgrade is decrypted to obtain the image upgrade for execution on the field programmable circuit.

### TECHNICAL FIELD

The present disclosure relates to securely upgrading field programmable devices, such as Field Programmable Gate Arrays (FPGAs).

### BACKGROUND

FPGAs are widely used in devices that have been deployed in the field, e.g., within host devices that are installed in fixed locations such as in data center electronics, network devices and mobile devices such as cellular phones and tablet devices. Field programmable devices, e.g., FPGAs, offer advantages over other approaches such as one-time programmable devices in that they are reconfigurable or reprogrammable during startup of their host device. Field programmable devices are typically programmed at the time of manufacture, with software upgrades having new features and bug fixes distributed at a later date. In order to upgrade a field programmable device, a new software image or bitstream is downloaded to the field programmable device. New image downloads often occur over a network from a remote location or locally at the host device itself.

One issue with providing field programmable device upgrades from a remote location is the security of the image during transit. In such situations, it is possible to intercept the image during transit. In other scenarios, a would-be hacker can extract the image from the physical hardware or steal encryption keys. Many field programmable devices run software that is the product of many man-years of software development and represents a significant cost to the device manufacturer. In order to secure the field programmable device image, a symmetric key is stored in the field programmable device and used to decrypt either stored or upgraded images. Thus, all of the devices manufactured for a particular host device model or in a particular timeframe have the same symmetric key. If the symmetric key is compromised, then all devices with that key are potentially compromised. One solution to this problem is to provide device specific keys. However, device specific keys require complex key management for which many manufactures are not willing to support, or to take the risk of lost keys.

### BRIEF DESCRIPTION OF THE DRAWINGS

FIG. 1 shows an example device including a field programmable device (FPD) programmable with an FPD image and associated FPD image update logic to reconfigure the FPD.

FIG. 2 is an example of a flowchart for operations at an upgrade facility for preparing an image upgrade for an FPD that is already deployed in the field, e.g., sold to a customer.

FIGS. 3a and 3b illustrate an example of a flowchart for operations at a device with an FPD for upgrading the FPD.

FIG. 4 is an example of a flowchart for an overview of a factory to deployment model for upgrading an FPD.

### DESCRIPTION OF EXAMPLE EMBODIMENTS

### Overview

In one embodiment, a method includes receiving a first encrypted software image configured to program a field programmable circuit or device in a computing device that contains the field programmable circuit, wherein a plurality of keys are stored in the computing device. The first encrypted software image is encrypted using a first key that corresponds to one of the plurality of keys. The first encrypted software image is decrypted using a second key of the plurality of keys to obtain a software image. The software image is encrypted using a third key of the plurality of keys to generate a second encrypted image. The second encrypted software image is stored in a storage device configured to provide the second encrypted software image to the field programmable circuit.

The first encrypted image may be further signed with an associated digital signature, where the digital signature is verified upon receipt at the computing device in order for the field programmable circuit software image to be upgraded. The computing device is booted up and the second encrypted software image is loaded into the field programmable circuit. The second encrypted software image is decrypted using a fourth key of the plurality of keys to obtain the software image. The first and second keys may comprise a public/private key pair according to a Public Key Encryption (PKI) scheme, and the third and fourth keys may comprise symmetric keys or a public/private key pair.

### Example Embodiments

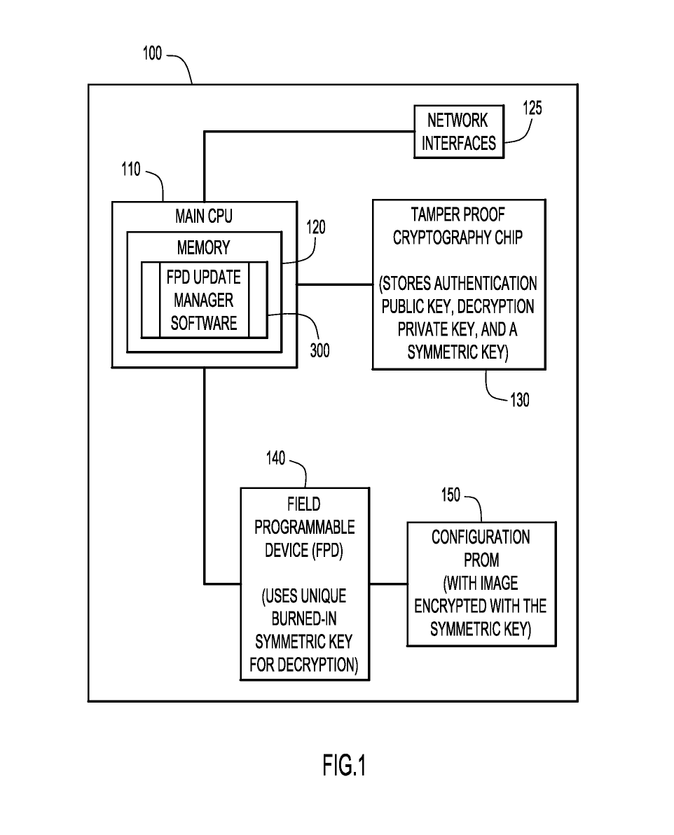

FIG. 1 shows an example block diagram of a computing device 100 configured according to the techniques described herein. Computing device 100 may comprise a processor 110, a field programmable device (FPD) 140 with an associated configuration non-volatile memory (NVM) 150, e.g., a Programmable Read-only Memory (PROM) or flash memory, one or more network interfaces 125 for network connectivity, and a tamper proof chip 130. Processor 110 may be a programmable processor, e.g., microprocessor, digital signal processor, or microcontroller or a fixed-logic processor such as an application specific integrated circuit (ASIC). The memory 120 may be of any type of tangible processor readable memory (e.g., random access, read-only, etc.) that is encoded with or stores instructions, such as FPD Update Manager software 300. In another example, software 300 may be executed by tamper proof chip 130 or executed by a combination of processor 110 and tamper proof chip 130. Alternatively, computing device 100 may be comprised of a fixed-logic processing device that is configured with firmware comprising instructions (e.g., FPD Update Manager software 300) that cause the processor 110 to perform the functions described herein. Briefly, software 300 manages the upgrade of new software images for FPD 140, and may be referred to herein simply as software 300.

Thus, computing device 100 may take any of a variety of forms, so as to be encoded in one or more tangible (e.g., non-transitory) storage media for execution, such as with fixed logic or programmable logic (e.g., software/computer instructions executed by a processor) and any processor may be a programmable processor, programmable digital logic (e.g., an FPGA) or an ASIC that generally comprises fixed digital logic, or a combination thereof. In general, software may be embodied in a processor readable medium that is encoded with instructions for execution by a processor that, when executed by the processor, are operable to cause the processor to perform the functions described herein.

Processor 110 and tamper proof chip 130, as, well as FPD 140 and PROM 150, may form a Trusted Computing Base (TCB). A TCB of a computer system, e.g., device 100, is the set of all hardware, firmware, and/or software components that provides a secure computing environment. In this regard, the tamper proof chip 130 may be a tamper proof cryptography chip (TPCC) that securely stores authentication, encryption keys, and decryption keys. The keys stored on tamper proof chip 130 may be supplied to processor 110 and FPD 140 for the authentication, encryption, and decryption techniques described herein. In another example, certain aspects of the authentication, encryption, and decryption techniques may be performed on tamper proof chip 130.

It is noted that the functionality described herein for computing device 100 is generally implemented as part of an embedded device such a cell phone or a network router. The techniques may also be implemented by non-embedded applications such as general purpose computers for which field programmable software images need to be securely downloaded during upgrade. The downloads may be performed over various network types, e.g., over a wireless or wireline network such as a Wide Area Network (WAN) or a Local Area Network (LAN), or network subset such as a Virtual Private Network (VPN) via one of networks interfaces 125.

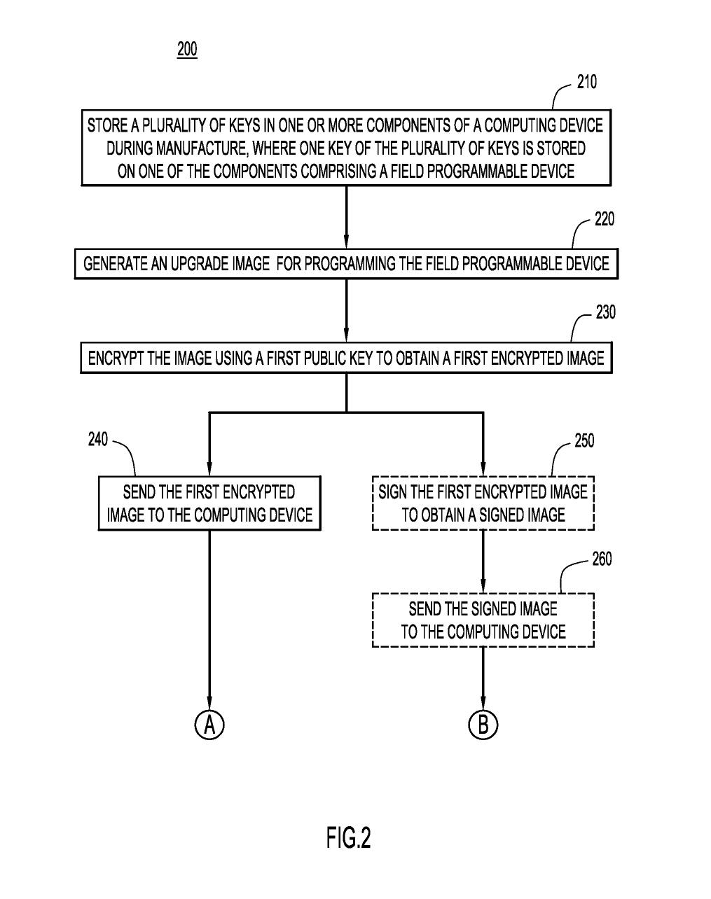

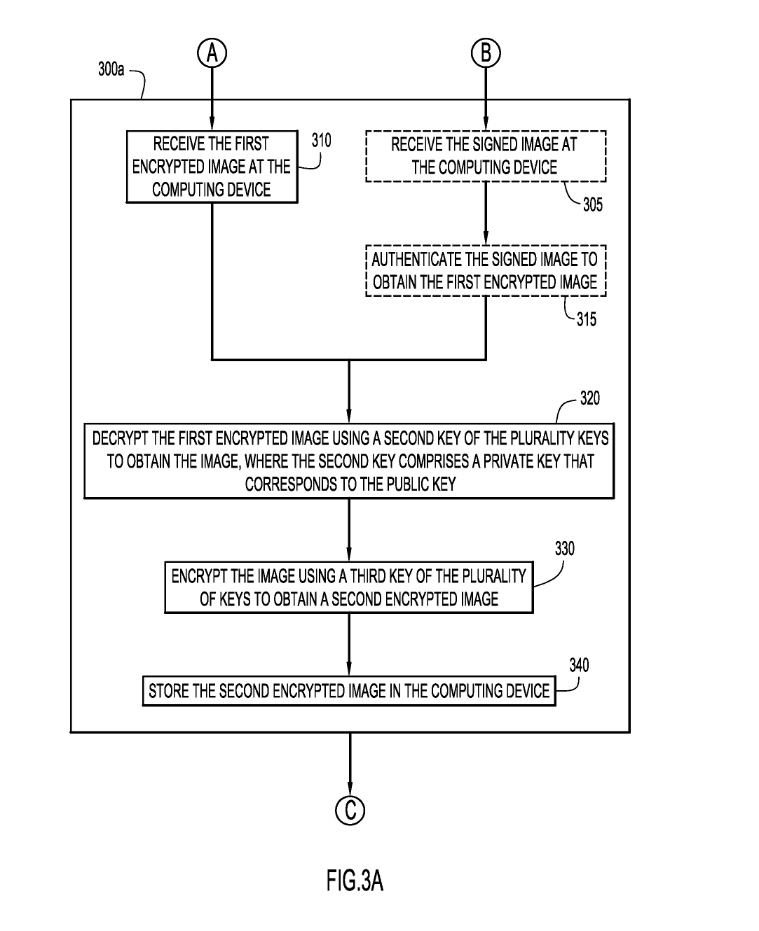

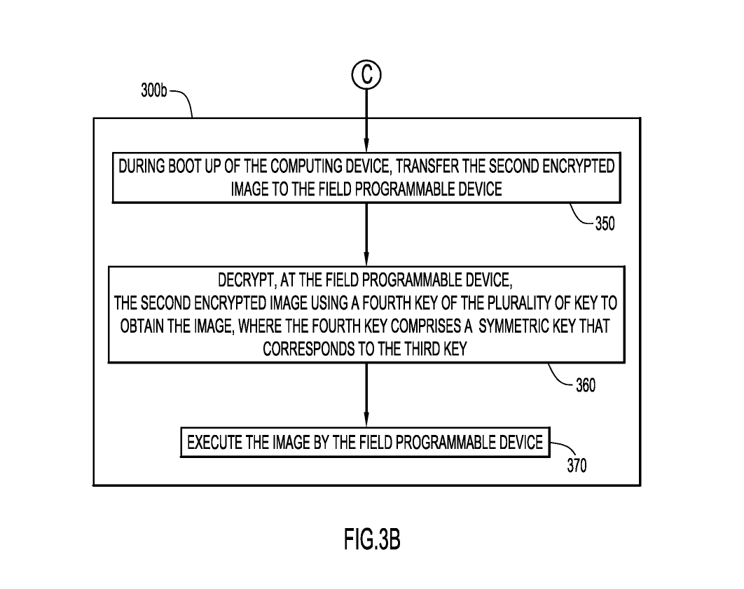

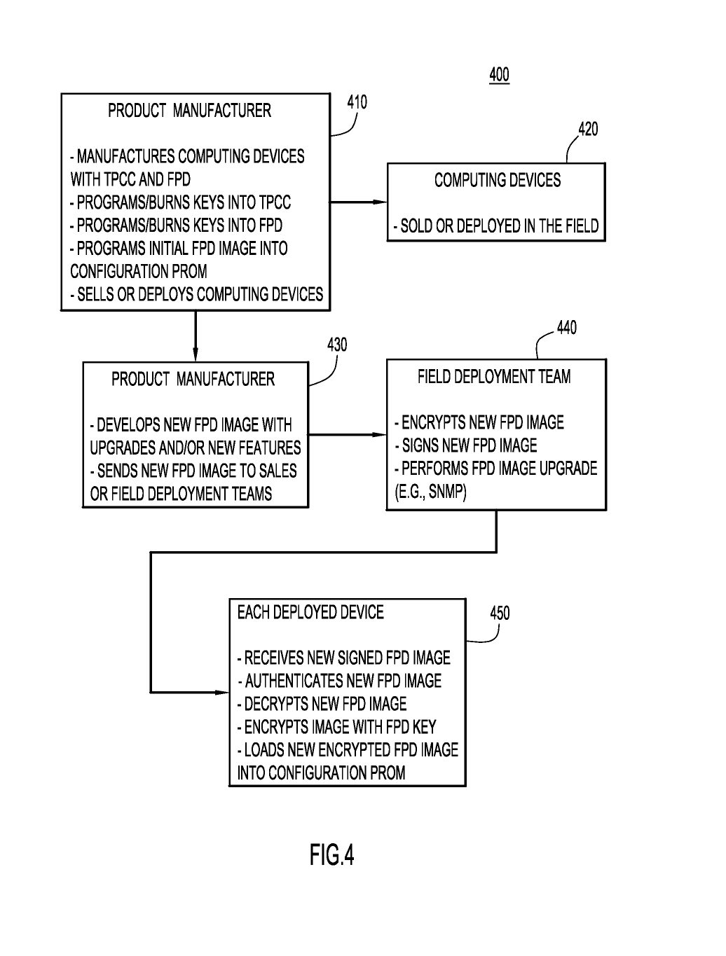

FIGS. 2, 3a, 3b, and 4 are flowcharts depicting various processes performed according to the techniques described herein. FIG. 2 depicts a process performed at the time of manufacture of computing device 100 to enable a secure upgrade of FPD 140, as well as for performing an actual upgrade by an upgrade team. FIGS. 3a and 3b illustrate a flowchart for operations of FPD Update Manager software 300 performed at the computing device 100 during a software upgrade of field programmable device 140. The operations of software 300 may be considered a continuation of the process shown in FIG. 2, but from the point of view of computing device 100. FIG. 4 is a flowchart depicting an overall process of the field programmable device configuration and upgrade process. Parts of the various flowcharts shown in the figures are optional, as indicated by the dashed boxes.

Turning now to FIG. 2, a process 200 is described. At 210, a plurality of keys are stored in one or more components of a computing device during manufacture, where one key of the plurality of keys is stored on one of the components comprising a field programmable processing device. In many typical applications, a decryption key is stored on the field programmable device. However, this key may be supplied by way of tamper proof chip 130 and not stored on the field programmable device. Thus, all or some of the keys may be stored on the tamper proof chip 130.

At 220, an upgrade software image is generated for programming the programmable processing device, e.g., field programmable device 140. The upgrade image is typically developed by engineers to solve software defects (bugs) or to add new features. The image is typically be tested in a test lab facility and passed to a marketing or upgrade team. At 230, the image is encrypted using a first key (e.g., a shared public key) to obtain a first encrypted image. Although a public key is generally referred to in the context of a Public Key Infrastructure (PKI) scheme (for private key decryption), other encryption mechanisms may be employed.

At this point, process 200 may branch, and the first encrypted image may be sent to the computing device, or optionally, the first encrypted image is digitally signed prior being sent. At 240, the first encrypted image is sent to the computing device, e.g., to computing device 100. From 240, the process continues to 310 in FIG. 3a as indicated in FIG. 2 and described hereinafter. At 250, the first encrypted image is digitally signed to obtain a signed image, prior to being sent, and at 260, the signed image is sent to the computing device. Digital signatures may employ various forms of encryption, e.g., PKI, and is used, among other things, to verify the authenticity of the sender. From 260, the process continues to 305 in FIG. 3a.

In order to send or download the first encrypted or signed image, any number of techniques may be employed. For example, the Trivial File Transfer Protocol (TFTP) may be used to transfer the encrypted image from a remote location to computing device 100 when computing device 100 is in a fixed location, e.g., routers and switches in a data center. The Simple Network Management Protocol (SNMP) may be used to manage computing device 100 during download. In one example, the new image may be stored in one section of partitioned NVM or in one of several NVMs such that the previous image version remains stored. The SNMP can be used to switch a pointer to point to the new image for use the next time the computing device is started or booted. Should an operational issue occur when executing the new image, the computing device can be switched back to the previous image. In another example, a user may connect a portable device, e.g., a cell phone or music player, to a general purpose computer such as a Personal Computer (PC). The upgrade image may then be downloaded via a web page or a device specific application running on the PC.

Referring now to FIGS. 3a and 3b, the operations of the FPD Update Manager software 300 are described. As mention above, software 300 manages the upgrade of new software images for an FPD, e.g., FPD 140. For ease of description, software 300 is broken up into two parts, flowchart 300a shown in FIG. 3a and flowchart 300b shown in FIG. 3b. Generally, the flowchart 300a depicts operations of a software image upgrade process, while flowchart 300b depicts operations performed when the FPD in the computing device executes the image upgrade. As shown in FIG. 3a, the branches are maintained from FIG. 2.

In FIG. 3a, at 310, the first encrypted image is received at the computing device. If the first encrypted image is digitally signed, the signed image is received at the computing device at 305. At 315, the signed image is authenticated to obtain the first encrypted image. Authentication may be performed, e.g., by processor 110 or tamper proof chip 130. The branches merge, and at 320, and the first encrypted image is decrypted using a second key of the plurality of keys to obtain the image, where the second key comprises a private key that corresponds to the aforementioned public key. Thus, the image that was encrypted with a public key is decrypted by a private key. At 330, the image is encrypted (re-encrypted) using a third key of the plurality keys to obtain a second encrypted image. The image may be re-encrypted using a symmetric key, e.g., using keys developed using the Advance Encryption Standard (AES). When a symmetric key is employed the same key is used for both encryption and decryption, thereby simplifying the cryptographic process. At 340, the second encrypted image is stored in the computing device, e.g., for execution by FPD 140 upon restart of the computing device or the FPD 140 itself. The second encrypted image is stored in some form of NVM, e.g., a configuration PROM.

After a period of time or immediately after the second encrypted image is stored, the second part of FPD Update Manager software 300, i.e., as depicted by flowchart 300b shown in FIG. 3b, is started. Referring to FIG. 3b, flowchart 300b is now described. At 350, during boot up of the computing device, the second encrypted image is transferred to the FPD. At 360, the FPD decrypts the second encrypted image using a fourth key of the plurality of keys to obtain the image. The fourth key may comprise a symmetric key that corresponds to the third key, although PKI type keys may be employed. At 370, the image is executed by the FPD. Under some circumstances, decryption by the FPD may fail and is therefore not executed. If an execution or decryption failure occurs, computing device 100 may send an error notification or log the error in a log file.

The techniques described in connection with process 200 and operations of software 300 provide a solution to existing security problems when upgrading field programmable devices. The security of FPGAs is relied upon to provide additional security of larger systems. Issues such as image counterfeiting and reverse engineering have led FPGA vendors to implement mechanisms such as bitstream encryption to secure an FPGA image when it is stored external to the FPD, e.g., in Static Random Access Memory (SRAM) based FPGAs. Bitstream encryption provides encryption, or encryption and authentication for the FPGA configuration to ensure that an external entity can not reverse engineer the bitstream and obtain the intellectual property contained therein. Additionally, encryption can help prevent counterfeiting because a key is needed to decrypt the bitstream, yet the key is held by the manufacturer and within the FPGA. A stolen bitstream may be loaded onto another device and exploit the advances of the intellectual property in the stolen FPGA image exploited.

In a typical bitstream encryption scheme, the bitstream is the firmware that programs the FPGA logic. In many FPGAs, the image is loaded into the FPGA at every power up of the device. The FPGA vendor provides a capability to insert a symmetric key into an FPGA (typically during manufacturing). The same symmetric key is used to encrypt the bitstream produced during development (tooling) by the FPGA vendor. Therefore, when the bitstream is programmed into a flash part or delivered to the system, it is encrypted with this symmetric key and ‘protected’ from being cloned or modified on that product. This form of protection exists, in part, because the FPGA itself uses a bitstream decryption key to decrypt and obtain the bitstream.

A problem with the existing bitstream encryption solutions used by FPGA vendors is in many cases they rely on cryptographic operations based on private keys stored within the FPGA itself. FPGAs and other programmable devices are typically poorly equipped to protect either keys or attacks on the cryptographic operations themselves, e.g., by way of side channel attacks. This weakness exists regardless of the type of cryptography used, e.g., symmetric or asymmetric.

There are tradeoffs that vendors face when choosing to activate a bitstream encryption scheme to protect an FPGA bitstream. Once activated, an FPGA cannot use a non-encrypted bitstream. There are two deployment models used today with bitstream encryption. With a first model, the vendor inserts a unique symmetric key into each FPGA at the time of manufacturing and then encrypts each FPGA image. The manufacturer is required to maintain these unique keys so that if a field upgrade of the FPGA bitstream is needed, each unique key can be used to deliver a uniquely encrypted bitstream to the device in the field. Thus, to be able to maintain per device keys, individually encrypted images are delivered. In a high volume operation, individual encryption becomes untenable.

With a second model, the vendor uses the same symmetric key across multiple devices, e.g., typically across a product line. The bitstream key per product line model has the weakness that if the symmetric key of a single product in a product line is ever compromised, then the entire product line is compromised.

Furthermore, new forms of hacker attacks have and are being developed. For example, side channel attacks that rely on differential power analysis are used to extract the symmetric key. Once the symmetric key is extracted, reprogramming of the device by a thief is possible, and if the same bitstream encryption key is used across every product in a product line (e.g., as the only viable use case for commercial vendors to employ), then entire product line is compromised.

The techniques described herein solve both of the above-described issues. By storing the appropriate keys on the host device, unique keys can be used for each field programmable device. Namely, a unique symmetric key can be programmed into each FPGA, thereby conserving FPGA logic and permitting manufacture of large volumes of FPGAs. In other words, each FPD has a unique symmetric key for encryption and decryption of the image executed by the FPGA. The unique symmetric key is not used in any other FPGA and may be stored in the host device or the FPGA itself, or both. It should be understood that while symmetric key cryptography is described herein in connection with FPGA or FPD cryptographic operations, any type of cryptography may be used, e.g., asymmetric key cryptography such as PKI.

Referring to FIG. 4, an example of a flowchart is shown for an overview of a factory-to-field deployment model for programming an FPD during manufacture, and upgrading the FPD after deployment in the field. At 410, a product manufacturer manufactures computing devices having a TPCC, e.g., tamper proof chip 130, and an FPD. The manufacturer programs, e.g., “burns,” keys into the TPCC and FPD, and may or may not program the initial image into the FPD. It should be noted that the keys may be burned by a separate vendor or a combination of vendors or manufacturers, typically under a non-disclosure agreement. At 420, the computing devices are sold or deployed.

At 430, the product manufacturer develops a new FPD image that includes new features and/or fixes to software defects. The product manufacturer may send the new FPD image to a server for download or to an FPD deployment team. The image may be upgraded by the field deployment team, e.g., for devices under control and ownership of the computing device. Alternatively, individual devices may be upgraded by individual device owners, e.g., directly by way of a server or a web browser initiated download that acts a convenient user interface.

At 440, the developer of the new FPD image makes the image available to the end user. In the case that many devices are to be upgraded within a short timeframe, a field deployment team may be used for the multi-device upgrade, e.g., using a multicast broadcast. Regardless of the environment, the new FPD image is encrypted and optionally signed. The image is delivered to devices, e.g., using SNMP.

At 450, a deployed device receives the new upgrade FPD image. If the image is signed, it is authenticated by the deployed device. The new FPD image is decrypted, e.g., using a stored private key. The new FPD image is re-encrypted using a symmetric key. By virtue of being a symmetric key, it is the same symmetric key that may be stored on the FPD. Once re-encrypted, the new re-encrypted FPD image is stored in memory, e.g., a configuration PROM. When the FPD is restarted, e.g., by a power up or external command, the re-encrypted image is loaded into the FPD. The re-encrypted image is decrypted, e.g., using the symmetric key. Accordingly, a unique symmetric key can be stored on the FPD and/or the TPCC.

To summarize, techniques are presented herein for securely upgrading an FPD, while enabling a unique, per FPD, key. Tamper proof chips are much more secure for cryptographic processing than are FPGAs. As a result, by combining tamper proof chips with FPGAs via an FPGA update manager, the bitstream encryption capabilities can be leveraged without creating unsupportable complexity or creating a single point of exposure via the FPGAs.

Thus, a method is provided comprising receiving a first encrypted software image configured to program a field programmable circuit in a computing device that contains the field programmable circuit, wherein a plurality of keys are stored in the computing device, and wherein the first encrypted software image is encrypted using a first key that corresponds to one of the plurality of keys; decrypting the first encrypted software image using a second key of the plurality of keys to obtain a software image; encrypting the software image using a third key of the plurality of keys to generate a second encrypted image; and storing the second encrypted software image in a storage device configured to provide the second encrypted software image to the field programmable circuit.

An apparatus is provided comprising a field programmable circuit; an image storage circuit configured to store software images for programming the field programmable circuit; a key storage circuit configured to store a plurality of keys; a network interface device configured to enable communications over a network and to receive a first encrypted software image configured to program the field programmable circuit, wherein the first encrypted software image is encrypted using a first key that corresponds to one of the plurality of keys; and a processor. The processor is configured to decrypt the first encrypted software image using a second key of the plurality of keys to obtain a software image; encrypt the software image using a third key of the plurality of keys to generate a second encrypted image; and store the second encrypted software image in the image storage circuit.

Further still, a processor readable storage media is provide that is encoded with instructions that, when executed by a processor, cause the processor to receive a first encrypted software image configured to program a field programmable circuit in a computing device that contains the field programmable circuit, wherein a plurality of keys are stored in the computing device, and wherein the first encrypted software image is encrypted using a first key that corresponds to one of the plurality of keys; decrypt the first encrypted software image using a second key of the plurality of keys to obtain a software image; encrypt the software image using a third key of the plurality of keys to generate a second encrypted image; and store the second encrypted software image in a storage device configured to provide the second encrypted software image to the field programmable circuit.

The above description is intended by way of example only.

What is claimed is:

1. A method comprising:
receiving a first encrypted software image configured to program a field programmable circuit in a computing device that contains the field programmable circuit, wherein a plurality of keys are stored in the computing device, and wherein the first encrypted software image is encrypted using a first key that corresponds to one of the plurality of keys;
decrypting the first encrypted software image using a second key of the plurality of keys to obtain a software image;
encrypting the software image using a third key of the plurality of keys to generate a second encrypted image; and
storing the second encrypted software image in a storage device configured to provide the second encrypted software image to the field programmable circuit.

2. The method of claim 1, wherein receiving comprises receiving the first encrypted image with an associated digital signature, the method further comprising:
authenticating the digital signature associated with the first encrypted software image.

3. The method of claim 1, further comprising:
booting up the computing device;
loading the second encrypted software image into the field programmable circuit; and
decrypting the second encrypted software image using a fourth key of the plurality of keys to obtain the software image.

4. The method of claim 3, wherein the third key and the fourth key are the same.

5. The method of claim 3, wherein the first and second keys comprise a public/private key pair according to a Public Key Encryption (PKI) scheme, and the third and fourth keys comprise one of symmetric keys and a public/private key pair.

6. The method of claim 3, further comprising storing the fourth key in the field programmable circuit, wherein decrypting the second encrypted software image comprises decrypting the second encrypted software image by the field programmable circuit using the fourth key stored on the field programmable circuit.

7. The method of claim 1, further comprising storing one or more of the plurality of keys in a tamper proof semiconductor device contained in the computing device.

8. The method of claim 7, further comprising retrieving one or more of the plurality of keys from the tamper proof semiconductor device.

9. The method of claim 1, wherein the field programmable circuit comprises one of a Field Programmable Gate Array (FPGA), an Application Specific Integrated Circuit (ASIC) and a System on a Chip (SOC); and the storage device comprises one of a configuration Programmable Read-Only Memory (PROM) and a Non-Volatile Memory (NVM).

10. The method of claim 1, further comprising storing one or more of the plurality of keys in the computing device during manufacture of the computing device.

11. The method of claim 1, wherein the software image comprises an upgrade to a previously stored software image in the computing device.

12. An apparatus comprising:
a field programmable circuit;
an image storage circuit configured to store software images for programming the field programmable circuit;
a key storage circuit configured to store a plurality of keys;
a network interface device configured to enable communications over a network and to receive a first encrypted software image configured to program the field programmable circuit, wherein the first encrypted software image is encrypted using a first key that corresponds to one of the plurality of keys; and
a processor that is configured to:
decrypt the first encrypted software image using a second key of the plurality of keys to obtain a software image;
encrypt the software image using a third key of the plurality of keys to generate a second encrypted image; and
store the second encrypted software image in the image storage circuit.

13. The apparatus of claim 12, wherein the network interface device is configured to receive the first encrypted image with an associated digital signature, and the processor is further configured to authenticate the digital signature associated with the first encrypted software image.

14. The apparatus of claim 12, wherein the processor is further configured to:
boot up the apparatus; and
load the second encrypted software image into the field programmable circuit, wherein the field programmable circuit is configured to decrypt the second encrypted software image using a fourth key of the plurality of keys to obtain the software image.

15. The apparatus of claim 14, wherein the first and second keys comprise a public/private key pair according to a Public Key Encryption (PKI) scheme, and the third and fourth keys comprise one of symmetric keys and a public/private key pair.

16. The apparatus of claim 12, wherein the key storage circuit comprises a tamper proof cryptography chip, and the field programmable circuit comprises one of a Field Programmable Gate Array (FPGA), an Application Specific Integrated Circuit (ASIC) and a System on a Chip (SOC); and the storage device comprises one of a configuration Programmable Read-Only Memory (PROM) and a Non-Volatile Memory (NVM).

17. A processor readable storage media encoded with instructions that, when executed by a processor, cause the processor to:
receive a first encrypted software image configured to program a field programmable circuit in a computing device that contains the field programmable circuit, wherein a plurality of keys are stored in the computing device, and wherein the first encrypted software image is encrypted using a first key that corresponds to one of the plurality of keys;
decrypt the first encrypted software image using a second key of the plurality of keys to obtain a software image;
encrypt the software image using a third key of the plurality of keys to generate a second encrypted image; and
store the second encrypted software image in a storage device configured to provide the second encrypted software image to the field programmable circuit.

18. The processor readable storage media of claim 17, wherein the instructions operable to receive comprises instructions operable to receive the first encrypted image with an associated digital signature, and further comprising instructions that, when executed by the processor, cause the processor to:
authenticate the digital signature associated with the first encrypted software image.

19. The processor readable storage media of claim 17, further comprising instructions that, when executed by the processor, cause the processor to:
boot up the computing device; and
load the second encrypted software image into the field programmable circuit, wherein the field programmable circuit is configured to decrypt the second encrypted software image using a fourth key of the plurality of keys to obtain the software image.

20. The processor readable storage media of claim 19, wherein the first and second keys comprise a public/private key pair according to a Public Key Encryption (PKI) scheme, and the third and fourth keys comprise one of symmetric keys and a public/private key pair.

21. The processor readable storage media of claim 19, further comprising instructions that, when executed by the processor, cause the processor to retrieve one or more of the second, third, and fourth keys from a key storage device.
